(19) United States
(12) Patent Application Publication
(10) Pub. No.: US 2024/0371394 A1
(43) Pub. Date: Nov. 7, 2024

(54) FEATURE AMOUNT OUTPUT MODEL GENERATION SYSTEM

(71) Applicant: NTT DOCOMO, INC., Chiyoda-ku (JP)

(72) Inventor: Keita YOKOYAMA, Chiyoda-ku (JP)

(73) Assignee: NTT DOCOMO, INC., Chiyoda-ku (JP)

(21) Appl. No.: 18/554,031

(22) PCT Filed: Mar. 17, 2022
(86) PCT No.: PCT/JP2022/012222

§ 371 Date: Oct. 5, 2023

(30) Foreign Application Priority Data
Apr. 27, 2021 (JP) 2021-074895

(51) Int. Cl. G10L 25/51; G10L 25/27; G10L 25/90

(52) U.S. Cl. CPC G10L 25/51; G10L 25/27; G10L 25/90

(57) ABSTRACT

A feature amount output model generation system is a system configured to generate a feature amount output model for inputting information based on singing data- and outputting a feature amount of the singing data, the system includes a singing data acquisition unit configured to acquire singing data for each of a plurality of songs, a division unit configured to divide each piece of singing data into a plurality of temporal sections, and a feature amount output model generation unit configured to generate a feature amount output model from the divided singing data through machine learning, wherein the feature amount output model generation unit performs machine learning according to criteria based on a distance between feature amounts of singing data relating to the same song and a distance between feature amounts of singing data relating to songs different from each other.

### TECHNICAL FIELD

The present invention relates to a feature amount output model generation system configured to generate a feature amount output model for inputting information based on singing data which is time-series voice data relating to singing of a song and outputting a feature amount of the singing data.

### BACKGROUND ART

In the past, recommending songs to a user on the basis of the user's singing history in karaoke has been proposed (see, for example, Patent Literature 1).

### CITATION LIST

### Patent Literature

[Patent Literature 1] Japanese Unexamined Patent Publication No. 2012-78387

### SUMMARY OF INVENTION

### Technical Problem

A key of a song is important during singing in karaoke. Therefore, similarly to the recommendation of songs as described above, recommending keys when a user sings can be considered. When keys are recommended, recommending the keys using singing data which is data of voices that have sung by the user in the past can be considered. More appropriate keys can be recommended by using the singing data. In addition, even when songs are recommended, the singing data can be used to make more appropriate recommendations.

Using a model for recommendation prepared in advance or the like to determine keys or songs to be recommended can be considered. In order to make appropriate recommendations, using a feature amount of the singing data rather than the singing data itself as an input to a model for recommendation or the like can be considered. However, no method of generating feature amounts from singing data for recommendation has been proposed in the past. For this reason, it has not been possible to make appropriate recommendations using singing data in the past.

An embodiment of the present invention was contrived in view of such circumstances, and an object thereof is to provide a feature amount output model generation system capable of generating a feature amount output model that appropriately outputs a feature amount from singing data.

### Solution to Problem

In order to achieve the above object, according to an embodiment of the present invention, there is provided a feature amount output model generation system configured to generate a feature amount output model for inputting information based on singing data which is time-series voice data relating to singing of a song and outputting a feature amount of the singing data, the system including: a singing data acquisition unit configured to acquire singing data for each of a plurality of songs used to generate a feature amount output model; a division unit configured to divide each piece of singing data acquired by the singing data acquisition unit into a plurality of temporal sections; and a feature amount output model generation unit configured to generate a feature amount output model for inputting information based on singing data of the divided section and outputting a feature amount of the singing data of the section from the singing data divided by the division unit through machine learning, wherein the feature amount output model generation unit performs machine learning according to criteria based on a distance between feature amounts of singing data relating to the same song and a distance between feature amounts of singing data relating to songs different from each other.

In the feature amount output model generation system according to an embodiment of the present invention, machine learning is performed according to criteria based on the distance between the feature amounts of the singing data relating to the same song and the distance between the feature amounts of the singing data relating to songs different from each other to generate a feature amount output model. The feature amount output model generated in this way can output a feature amount appropriate for use in recommendation and the like in which the degree of similarity between songs is considered.

That is, with the feature amount output model generation system according to an embodiment of the present invention, it is possible to generate a feature amount output model that appropriately outputs a feature amount from the singing data.

### Advantageous Effects of Invention

The feature amount output model generated according to an embodiment of the present invention can output a feature amount appropriate for use in recommendation and the like in which the degree of similarity between songs is considered. That is, according to an embodiment of the present invention, it is possible to generate a feature amount output model that appropriately outputs a feature amount from the singing data.

### BRIEF DESCRIPTION OF DRAWINGS

FIG. 1 is a diagram illustrating a functional configuration of a feature amount output model generation system according to an embodiment of the present invention.

FIG. 2 is a diagram illustrating an example of singing data used to generate a feature amount output model.

FIG. 3 is a diagram illustrating generation of the feature amount output model through machine learning.

FIG. 4 is a graph illustrating an example of feature amounts which are output by the feature amount output model.

FIG. 5 is a flowchart illustrating processing executed by the feature amount output model generation system according to the embodiment of the present invention.

FIG. 6 is a diagram illustrating a hardware configuration of the feature amount output model generation system according to the embodiment of the present invention.

### DESCRIPTION OF EMBODIMENTS

Hereinafter, an embodiment of a feature amount output model generation system according to the present invention will be described in detail with reference to the accompanying drawings. Meanwhile, in the description of the drawings, the same components are denoted by the same reference numerals and signs, and thus description thereof will not be repeated.

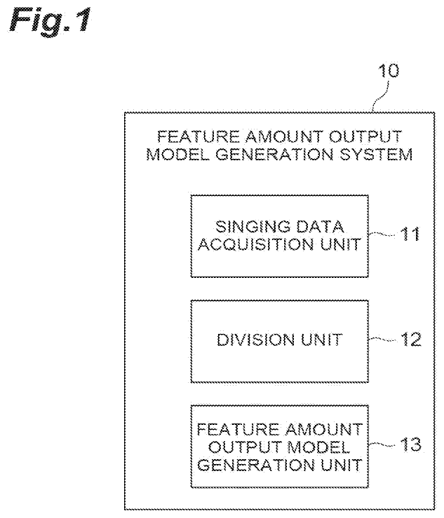

FIG. 1 shows a functional configuration of a feature amount output model generation system 10 according to the present embodiment. The feature amount output model generation system 10 is a system (device) that generates a feature amount output model. The feature amount output model (feature amount generation model) inputs information based on singing data which is time-series voice data relating to singing of a song, and generates and outputs the feature amount of the singing data. The singing data is, for example, data based on a user's voice recorded when the user sings a song in karaoke. The specific type of singing data will be described later. Meanwhile, the singing data does not necessarily have to be based on a user's singing insofar as it is time-series voice data relating to singing of a song. For example, the singing data may be voice-based data (model data) that assumes singing for which a perfect score can be obtained in a karaoke scoring system.

The feature amount of the singing data which is output by the feature amount output model is used, for example, for a key (key change) or song recommendation when a user sings a song in karaoke. How the output feature amount is specifically used will be described later. The feature amount output model generation system 10 generates (infers) a feature amount output model through machine learning. That is, the feature amount output model is a trained model generated through machine learning (machine learning model).

The feature amount output model generation system 10 is realized by a computer such as, for example, a personal computer (PC) or a server device. In addition, the feature amount output model generation system 10 may be realized by a plurality of computers, that is, computer systems.

Next, the functions of the feature amount output model generation system 10 according to the present embodiment will be described. As shown in FIG. 1, the feature amount output model generation system 10 is configured to include a singing data acquisition unit 11, a division unit 12, and a feature amount output model generation unit 13.

The singing data acquisition unit 11 is a functional unit that acquires singing data for each of a plurality of songs, which is used to generate a feature amount output model. The singing data acquisition unit 11 may acquire singing data including data indicating the length of a time-series pitch.

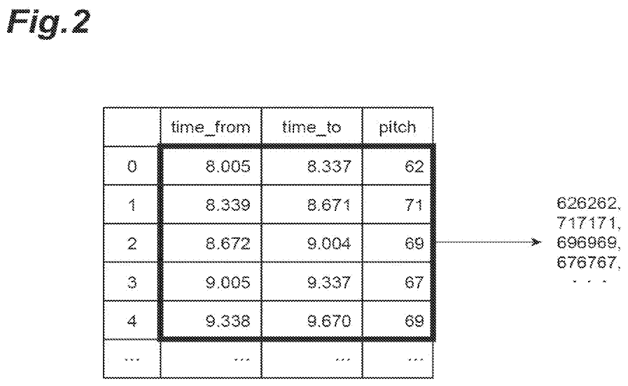

The singing data is, for example, information indicating the duration of the same pitch length of voice (song note information) as shown in FIG. 2. In addition, the singing data is information in units of songs, and it is possible to identify which song the data is related to by, for example, associating it with an ID of the song. The duration is indicated, for example, by the elapsed time from the start time when the song is played. The value in the “pitch” column shown in FIG. 2 is information indicating the pitch. Specifically, the value in the “pitch” column is a note number (MIDI number, MIDI key). For example, a value of 62 in the “pitch” column corresponds to D4 in the international-style key. The information in the “time_from” and “time_to” columns shown in FIG. 2 indicates a timing at which singing (vocalization) at the corresponding pitch is started and a timing at which it is terminated. The units of “time_from” and “time_to” are seconds. The numerical values on the left side of FIG. 2 are the serial numbers of the information.

For example, the data in the row numbered 0 in FIG. 2 indicates that the pitch of which the note number is 62 continued for 0.332 seconds from the point in time of 8.005 seconds to the point in time of 8.337 seconds with the start time of the song as the reference (0 seconds).

Meanwhile, a user usually starts singing after a certain amount of time has passed since the start time of the song due to the presence of an intro or the like. Therefore, the first “time_from” is not 0 seconds. In the singing data shown in FIG. 2, the first “time_from” is 8.005 seconds.

The singing data shown in FIG. 2 can be obtained, for example, by analyzing voices that have sung in a conventional karaoke system or the like (karaoke music file). The singing data acquisition unit 11 acquires, for example, singing data obtained from voice recorded when a user sings in a karaoke system from the karaoke system. Alternatively, the singing data acquisition unit 11 may acquire raw data of the voice relating to the user's singing, and generate and acquire singing data using conventional methods. In addition, the singing data acquisition unit 11 may acquire singing data using methods other than those described above. Meanwhile, the singing data acquired by the singing data acquisition unit 11 does not need to be based on the user's actual singing, and need only be data in the format shown in FIG. 2 assuming actual singing. In addition, the singing data does not necessarily have to be that shown in FIG. 2, and need only be time-series voice data relating to singing of a song.

The singing data acquisition unit 11 acquires a plurality of pieces of singing data for songs different from each other. Meanwhile, the user who sang in relation to the singing data acquired by the singing data acquisition unit 11 may be any user, or may be a plurality of users. In addition, the user may be the same user as a user who sang in relation to singing data for which the feature amount is output by the feature amount output model (that is, for example, a user who is a target for recommendation), or may be a different user. The singing data acquisition unit 11 acquires a sufficient number of pieces of singing data to perform machine learning to be described later. The singing data acquisition unit 11 outputs the acquired singing data to the division unit 12.

The division unit 12 is a functional unit that divides each piece of singing data acquired by the singing data acquisition unit 11 into a plurality of temporal sections. As will be described later, machine learning is performed using the singing data divided into temporal sections. The division unit 12 performs division as follows.

The division unit 12 inputs the singing data from the singing data acquisition unit 11. The division unit 12 divides each piece of input singing data into a plurality of sections on the basis of a division rule stored in advance. The division unit 12 divides each piece of singing data into a certain number of sections. The division unit 12 equally divides the time slot from the first “time from” of the singing data to the last “time_to” thereof, that is, the time slot related to the singing data, so that the above certain number is reached, and sets the equally divided timings (times) as timings to be used for delimiters. In a case where the timing to be used for the delimiter is included in a time slot with the consecutive identical pitch (that is, a time slot from “time from” to “time_to” associated with one “pitch” value), the delimiter of a section is set as the beginning or end of the time slot, whichever is closer to the timing. By making a division into sections in this way, the consecutive identical pitch is not divided into a plurality of sections. For example, the data numbered 0 to 4 shown in FIG. 2 is data of one section (first section).

Meanwhile, the number of sections to be divided may be a number set in advance for each song rather than a certain number. In addition, the timing used for the delimiter may be a timing set in advance for each song rather than the equally divided timing as described above. The division unit 12 outputs the singing data to be divided and information indicating the divided sections to the feature amount output model generation unit 13.

The feature amount output model generation unit 13 is a functional unit that generates a feature amount output model from the singing data divided by the division unit 12 through machine learning. The feature amount output model is a model that inputs information based on the singing data of the divided section and outputs the feature amount of the singing data of the section. The feature amount output model generation unit 13 performs machine learning according to criteria based on the distance between the feature amounts of the singing data relating to the same song and the distance between the feature amounts of the singing data relating to songs different from each other.

The feature amount output model generation unit 13 may perform machine learning so that the distance between the feature amounts of the singing data relating to the same song is shorter than the distance between the feature amounts of the singing data relating to songs different from each other. The feature amount output model generation unit 13 may determine the section of the singing data to be used for machine learning on the basis of the distance between the feature amounts output by the feature amount output model in the process of generation. The feature amount output model generation unit 13 may convert the data indicating the length of the pitch included in the singing data divided by the division unit 12 into a word which is a character string corresponding to the length of the pitch for each consecutive identical pitch, and generate a feature amount output model that inputs information based on the converted word.

The feature amount which is output by the feature amount output model is a vector having the number of dimensions set in advance (N-dimensional vector). That is, the feature amount output model is a model for performing Embedding. As will be described later, the singing data of the section is converted into words, and the feature amounts are generated from the converted words. The feature amount output model is configured to include, for example, a neural network. More specifically, the feature amount output model is a long short term memory (LSTM) appropriate to time-series data. However, the feature amount output model may be any model other than the above insofar as it is a model which is generated through machine learning to input singing data of a section and output the feature amount of the singing data of the section.

When keys or songs are recommended, the degree of similarity between songs can be a very important feature of a user's preference or ease of singing of songs. The degree of similarity between songs here refers to how much the songs have the same rhythm, melody, and musical scale patterns, and how close the pitch of a sound is. As described above, the feature amount output model inputs information based on singing data. In addition, the feature amount output model is generated in consideration of the distance between the feature amounts of the singing data relating to the song. The feature amount which is output by the feature amount output model generated in this way is obtained considering the degree of similarity between songs. Although music is expressed by rhythm, melody, musical scale patterns, and the like, it has been conventionally been difficult to calculate the degree of similarity between songs with respect to individual features such as rhythm, melody, and musical scale patterns.

The feature amount output model generation unit 13 generates a feature amount output model as follows. The feature amount output model generation unit 13 inputs the singing data and the information indicating the divided sections from the division unit 12. The feature amount output model generation unit 13 converts each consecutive identical pitch of the singing data (each row in FIG. 2) into a word which is a character string corresponding to the length of the pitch. First, the feature amount output model generation unit 13 calculates the temporal length of the consecutive identical pitch. The length in units of seconds can be calculated by subtracting the value of “time from” from the value of “time_to.” Subsequently, the feature amount output model generation unit 13 divides the calculated length by a unit time set in advance. The unit time set in advance is, for example, 0.1 seconds. The feature amount output model generation unit 13 rounds the calculated value to an integer. Rounding is performed using a method set in advance, for example, rounding off, truncation, or rounding up. The feature amount output model generation unit 13 sets a character string in which a value indicating the pitch is continuously lined up by the calculated integer as a word of the consecutive identical pitch.

For example, for the data of pitch numbered 0 in FIG. 2, the temporal length is first calculated as 8.337-8.005=0.332 seconds. Subsequently, a value of 0.332/0.1-3.32 is calculated by dividing the calculated value by a unit time set in advance. The value is rounded off to 3 which is an integer. The sequence “626262” in which a value 62 indicating the pitch is continuously lined up by that number is a word (note Embedding) for data of the pitch. The above word indicates how long the pitch lasts. In the above example, the wordification is performed on the basis of how many 10-1 seconds the pitch lasts. A word expresses the pitch and length of a sound. The feature amount output model generation unit 13 converts all pitch data into words.

The feature amount output model generation unit 13 thus encodes the singing data based on the elapsed time of the same pitch (same sound). This makes it possible to irregularly continuous singing data (sound information) to be treated as information used to generate a feature amount output model. With the above encoding, it is expected that information with the same pitch but slightly different lengths, information with close pitches but the same length, and the like can be treated as similar information.

As preprocessing of generating a feature amount output model, the feature amount output model generation unit 13 converts each converted word into an input feature amount to be input to the feature amount output model. Meanwhile, in the following description, the term “feature amount” simply referred to here indicates a feature amount which is an output of the feature amount output model, and the feature amount converted from a word is referred to as an input feature amount. The input feature amount is a vector having the number of dimensions set in advance. Conversion from a word to an input feature amount is performed, for example, using conventional natural language processing methods. Specifically, the conversion is performed using a model generated through fastText. The above word may be used to generate a model through fastText which is machine learning.

By using fastText, words which are close to each other in appearance can be meaningfully grouped by considering the grouping of letters that make up a given word. Therefore, although “7171” and “717171” are different words, these words are treated as close in terms of semantic distance because they have commonality in their component “71.”

The feature amount output model generation unit 13 uses the input feature amounts converted from the words included in the section in the order in which the words appear in the singing data as inputs to the feature amount output model of the section. For example, in the feature amount output model, neurons corresponding to the number of dimensions of the vector which is an input feature amount are disposed in an input layer. In addition, neurons corresponding to the number of dimensions (N described above) of the vector which is a feature amount are disposed in an output layer. The feature amount output model sequentially inputs the input feature amount included in the section for each input feature amount. The feature amount output model outputs a feature amount when all input feature amounts included in the section are input.

The feature amount output model generation unit 13 performs machine learning for generating a feature amount output model using information on three sections as one set. The three sections are a predetermined section (anchor), another section of the same song as the predetermined section (positive), and another section of a song different from the predetermined section (negative). The feature amount output model generation unit 13 selects (extracts) the above three section.

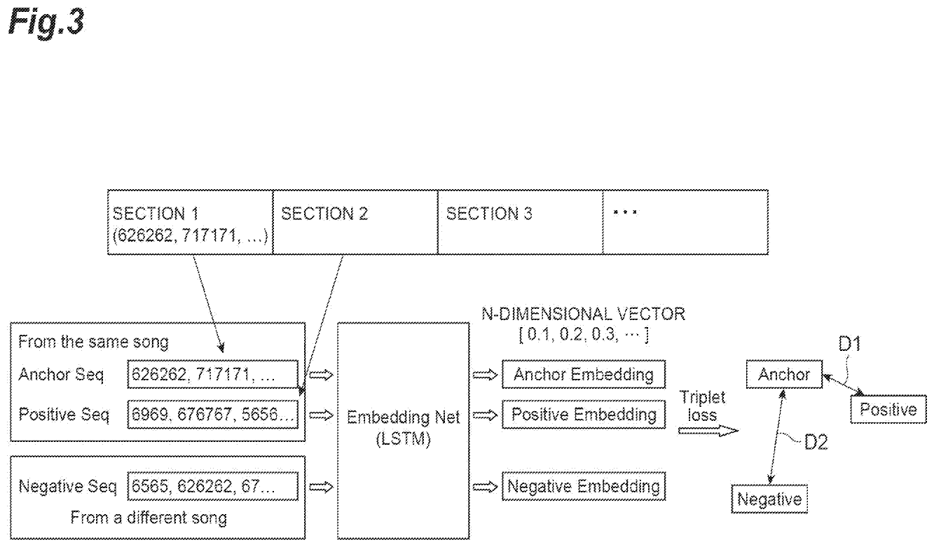

The feature amount output model generation unit 13 performs machine learning using the information on the three sections (set of input feature amounts) selected as shown above in FIG. 3 as inputs to the feature amount output model. From the feature amount output model, feature amounts are obtained as outputs for each of the three sections. Specifically, as shown in FIG. 3, Anchor Embedding which is the feature amount of the anchor is obtained from Anchor Seq which is information on an input anchor through Embedding Net which is a feature amount output model. Positive Embedding which is a positive feature amount is obtained from Positive Seq which is positive information. Negative Embedding which is a negative feature amount is obtained from Negative Seq which is negative information. Meanwhile, in FIG. 3, words are shown to be input to the feature amount output model, but in reality the input feature amount is input to the feature amount output model.

The feature amount output model generation unit 13 performs machine learning based on the feature amounts to be output, that is, Anchor Embedding, Positive Embedding, and Negative Embedding described above. The feature amount output model generation unit 13 performs machine learning so that a distance D1 between Anchor Embedding and Positive Embedding (distance between the anchor and positive) is shorter than a distance D2 between Anchor Embedding and Negative Embedding (distance between the anchor and negative) as shown on the right side of FIG. 3. The distances may be Euclidean distances in the N-dimensional space which is the vector space of the feature amount (feature space), or may be any other distance.

Specifically, the feature amount output model generation unit 13 performs machine learning with the following loss function Loss ( ).

$$Loss ( A , P , N ) = Max ( {‖ f ( A ) - f ( P ) ‖}^{2} - {‖ f ( A ) - f ( N ) ‖}^{2} + α , 0 )$$

In the above formula, A is Anchor Seq. P is Positive Seq. N is Negative Seq. In addition, f(X) is an Embedding vector obtained as an output when X is input to Embedding Net. ∥f(A)−f(P)∥ is between the anchor and positive. ∥f(A)−f(N)∥ is the distance between the anchor and negative. In addition, α is a hyperparameter set in advance and is a value indicating how much the difference between the anchor-positive distance and the anchor-negative distance should be. Max (X, Y) is a function of which the function value is the larger of X and Y. Machine learning itself based on the loss function may be performed in the same way as a conventional method.

The feature amount output model generation unit 13 selects three sections, that is, anchor, positive, and negative, from the sections indicated by the information input from the division unit 12, and performs machine learning using the information on the selected sections. The feature amount output model generation unit 13 repeatedly performs selection of three sections and machine learning to generate a feature amount output model. For example, the feature amount output model generation unit 13 generates a feature amount output model by repeating the above process until the generation of the feature amount output model converges on the basis of conditions set in advance, or a specified number of times set in advance, as a conventional method.

The three sections, that is, anchor, positive, and negative, are selected as follows. For example, the feature amount output model generation unit 13 selects the three sections through random sampling. In this case, the feature amount output model generation unit 13 randomly selects a song for each repetition, that is, for each epoch of learning, and randomly selects two sections included in the selected song to be the anchor and positive. Further, the feature amount output model generation unit 13 randomly selects a song different from the selected song and randomly selects one section included in the selected song to be negative.

Alternatively, the feature amount output model generation unit 13 may select negative using the feature amount output model in the process of generation. In this case, the anchor and positive are selected in the same way as above. The feature amount output model generation unit 13 randomly selects a song different from the songs including the anchor and positive. In this case, there may be a plurality of different songs. The feature amount output model generation unit 13 randomly selects sections included in the selected song as negative candidates. In this case, the number of negative candidates is multiple, for example, a number set in advance (N).

The feature amount output model generation unit 13 calculates the feature amount of the anchor and the feature amount of each of the negative candidates using the feature amount output model in the process of generation. Next, the feature amount output model generation unit 13 calculates the distance between the anchor and the negative candidate for each negative candidate from the calculated feature amount. The feature amount output model generation unit 13 determines negative candidates for which the calculated distance is within a threshold set in advance as negatives used for machine learning. Adopting negatives in this way requires distance calculation for each sampling, whereas learning proceeds intensively for negatives which should originally far from the anchor.

Meanwhile, the negative candidates may be all sections of all songs other than the anchor song, but instead of using all of them as candidates, negatives may be determined using a certain number, N, of negative candidates in consideration of distance calculation as described above. This makes it possible to increase the processing speed of machine learning. Meanwhile, the process of determining sections used for machine learning may be performed as a mini-batch process.

The feature amount output model generation unit 13 outputs the generated feature amount output model. For example, it transmits or outputs the feature amount output model to other devices or modules that use the feature amount output model. Alternatively, the feature amount output model generation unit 13 may store the generated feature amount output model in the feature amount output model generation system 10 so that it can be used by other devices or modules that use the feature amount output model.

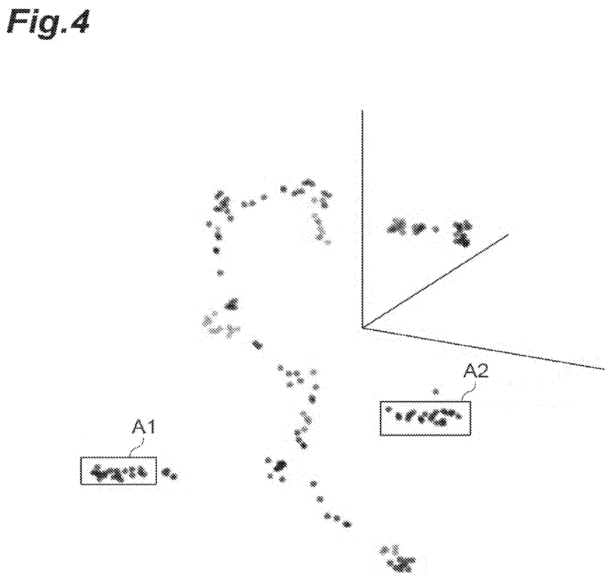

FIG. 4 shows an example of feature amounts which are output by the feature amount output model generated by the feature amount output model generation system 10. In FIG. 4, one point corresponds to the feature amount of one section. In addition, points of the same color (same density) correspond to points of the same song. In FIG. 4, the feature amount which is a high-dimensional vector is converted (dimensionally compressed) into a three-dimensional vector. The feature amounts of sections included in the same song are the feature amounts of positions close to each other. In FIG. 4, the points included in rectangular areas A1 AND A2 correspond to the feature amounts of sections included in the same song for each of the areas A1 and A2. Meanwhile, even if the songs are different from each other, the feature amounts of sections between songs with similar melody, genre, and the like are closer to each other than the feature amounts of sections between songs with different melody, genre, and the like. For example, even if the songs are different from each other, the distances between the feature amounts of sections in pop songs are closer to each other than the distances between the feature amounts of sections in pop songs and enka songs.

The feature amount output model which is a trained model generated by the feature amount output model generation system 10 is assumed to be used as a program module which is a portion of artificial intelligence software. The feature amount output model is used, for example, in a computer including a central processing unit (CPU) and a memory, and the CPU of the computer operates in accordance with a command from the feature amount output model stored in the memory. For example, the CPU of the computer operates to input information to the feature amount output model, perform calculations according to the feature amount output model, and output results from the feature amount output model in accordance with the command. Specifically, the CPU of the computer operates to input information to the input layer of the neural network, perform calculations based on trained weighting coefficients and the like in the neural network, and output results from the output layer of the neural network in accordance with the command.

The feature amount output model generated as described above is used as follows. For example, the feature amount output model is used to recommend keys or songs when songs are sung in karaoke. Specifically, it is used to make the above recommendation based on the past singing performance data of a user which is a target for recommendation. The singing performance data includes the same singing data as the singing data acquired by the singing data acquisition unit 11 described above.

A feature amount (Embedding) is generated from the singing data using the feature amount output model. Meanwhile, in this case, information to be input to the feature amount output model (for example, the above-described input feature amount) is generated from the singing data in the same way as when the feature amount output model is generated in the feature amount output model generation system 10. Meanwhile, the information to be input to the feature amount output model is information for each section of the singing data. Division into sections is also performed in the same way as above.

The feature amounts for each section may be lined up in the order of the sections for each song and concatenated to each other to obtain the feature amounts for each song. That is, concatenation of the feature amounts may be performed. In the case of simple concatenation, the dimension of the vector which is the feature amount per song is the number of dimensions of the vector which is the feature amount output by feature amount output model x the number of sections of the song. In addition, vectors may be integrated (averaged or added) at the time of concatenation to obtain feature amounts for each song of lower dimension.

Data of the past singing performance of a user which is a target for recommendation can be used for recommendation by using it as the feature amount for each song relating to singing as described above. In the case of recommendation of keys, the singing data which is model data for each key of a song that the user intends to sing may be converted into feature amounts using the feature amount output model in the same way as above. Meanwhile, in a case where the key of the singing data which is model data is changed, the value of the pitch shown in FIG. 2 need only be changed. For example, in a case where the key is raised by one, the value of the pitch, if it is 62, would be changed to 63. Thereby, if the word before change corresponding to the pitch is “626262,” the word after change would be “636363.”

The recommendation is performed by using, for example, the feature amount related to the above singing performance and the feature amount related to model data as inputs to use a model for recommendation (Dense) that outputs a value indicating the degree to which the user's singing matches the key related to the model data. The above value need only be calculated using the model data of a plurality of keys different from each other to recommend a key with the highest value. The model for recommendation may be created using a conventional machine learning method or the like.

By changing the height of the key of a certain song as described above, for example, even if a song to be recommended to a woman is a song by a male singer, it is possible to obtain the degree of similarity which is close to a song of a female singer sung by the woman in the past by changing the key.

Even in the case of recommendation of songs, model data of songs which are candidates for recommending singing to the user need only be used. In that case, the recommendation is performed by using, for example, the feature amount related to the above singing performance and the feature amount related to model data as inputs to use a model for recommendation that outputs a value indicating the degree to which a song related to the model data is to be recommended. The above value need only be calculated using the model data of a plurality of songs different from each other to recommend a song with the highest value.

The above is an example of recommendation using the feature amount which is output by the feature amount output model, and may be used for recommendations other than the above. In addition, the feature amount output model may be used for applications other than recommendation. The functions of the feature amount output model generation system 10 according to the present embodiment have been described above.

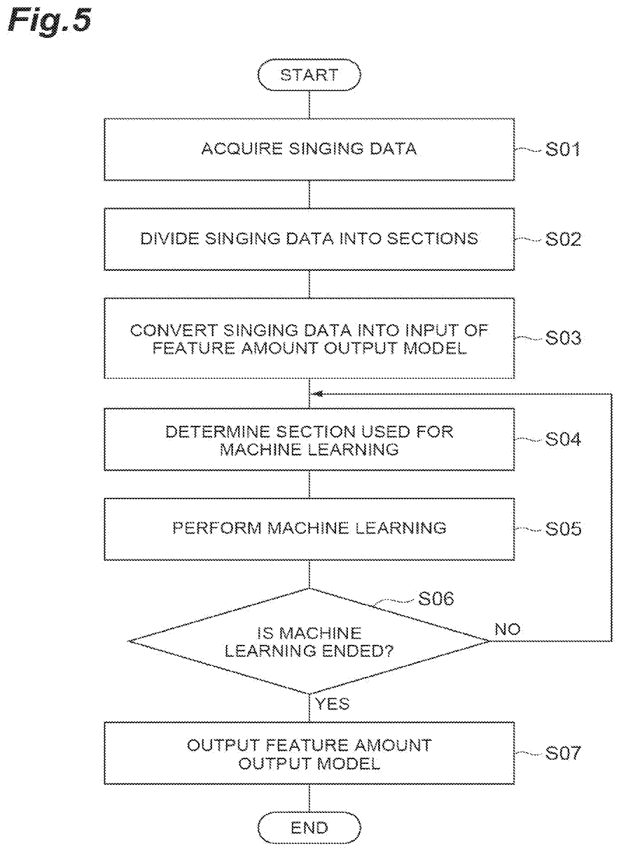

Next, processing which is executed by the feature amount output model generation system 10 according to the present embodiment (method of operation which is performed by the feature amount output model generation system 10) will be described with reference to the flowchart of FIG. 5.

In this process, the singing data acquisition unit 11 acquires singing data for each of a plurality of songs (S01). Next, each piece of singing data is divided into a plurality of temporal sections by the division unit 12 (S02). Next, the singing data of each section is converted into the input format of the feature amount output model by the feature amount output model generation unit 13 (S03). Specifically, the singing data is converted into words according to the length of the pitch. In addition, the words are converted into input feature amounts.

Next, a section used for machine learning is determined by the feature amount output model generation unit 13 (S04). Specifically, the above-described three sections of anchor, positive, and negative are determined. Next, the feature amount output model generation unit 13 performs machine learning for generating a feature amount output model using information on the determined section (S05). Specifically, as described above, machine learning is performed according to criteria based on the distance between the feature amounts of the singing data relating to the same song and the distance between the feature amounts of the singing data relating to songs different from each other. Next, the feature amount output model generation unit 13 determines whether to end machine learning (S06).

In a case where it is determined that machine learning is not ended, the above processes of S04 to S06 are performed again. In a case where it is determined that machine learning is ended, the generated feature amount output model is output from the feature amount output model generation unit 13 (S07). This is a process which is executed by the feature amount output model generation system 10 according to the present embodiment.

As described above, in the present embodiment, machine learning is performed according to criteria based on the distance between the feature amounts of the singing data relating to the same song and the distance between the feature amounts of the singing data relating to songs different from each other to generate a feature amount output model. The feature amount output model generated in this way can output a feature amount appropriate for use in, for example, recommendation and the like in which the degree of similarity between songs is considered as described with reference to FIG. 4. That is, according to the present embodiment, it is possible to generate a feature amount output model that appropriately outputs a feature amount from the singing data. As a result, it is possible to extract similar songs or to recommend keys or songs with a higher degree of accuracy.

In addition, as in the above-described embodiment, machine learning may be performed so that the distance between the feature amounts of the singing data relating to the same song is shorter than the distance between the feature amounts of the singing data relating to songs different from each other. According to such a configuration, it is possible to reliably generate a feature amount output model that appropriately outputs a feature amount from the singing data. However, machine learning does not necessarily have to be performed as described above insofar as the machine learning is performed according to criteria based on the distance between the feature amounts of the singing data relating to the same song and the distance between the feature amounts of the singing data relating to songs different from each other.

In addition, as in the above-described embodiment, sections of the singing data used for machine learning (for example, three sections of anchor, positive, and negative described above) may be determined on the basis of the distance between the feature amounts which are output by the feature amount output model in the process of generation. According to such a configuration, it is possible to efficiently perform machine learning as described above, and to, as a result, generate a feature amount output model which is more advanced in learning with respect to the same learning process. Alternatively, it is possible to reduce the number of learning processes in generating the feature amount output model. However, the determination of the section used for machine learning need not be performed as described above.

In addition, as in the above-described embodiment, the singing data may include data indicating the length of the time-series pitch. According to such a configuration, it is possible to reliably and appropriately generate a feature amount output model. In addition, the data indicating the length of the pitch included in the divided singing data may be converted into a word which is a character string corresponding to the length of the pitch for each consecutive identical pitch to generate a feature amount output model that inputs information based on the converted word. According to such a configuration, the singing data can be treated appropriately and easily using the conventional natural language processing methods described above in generating a feature amount output model. As a result, it is possible to appropriately and easily generate a feature amount output model. However, the singing data need not be those described above, and need only be time-series voice data relating to singing of a song. In addition, the singing data need not be treated as words as described above, and may be treated in any format insofar as it can be input to the feature amount output model.

Meanwhile, the block diagram used in the description of the above embodiment represents blocks in units of functions. These functional blocks (constituent elements) are realized by any combination of at least one of hardware and software. In addition, a method of realizing each functional block is not particularly limited. That is, each functional block may be realized using one device which is physically or logically coupled, or may be realized using two or more devices which are physically or logically separated from each other by connecting the plurality of devices directly or indirectly (for example, using a wired or wireless manner or the like). The functional block may be realized by combining software with the one device or the plurality of devices.

Examples of the functions include determining, deciding, judging, calculating, computing, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating (or mapping), assigning, and the like, but there is no limitation thereto. For example, a functional block (constituent element) for allowing a transmitting function is referred to as a transmitting unit or a transmitter. In either case, as described above, realization methods are not particularly limited.

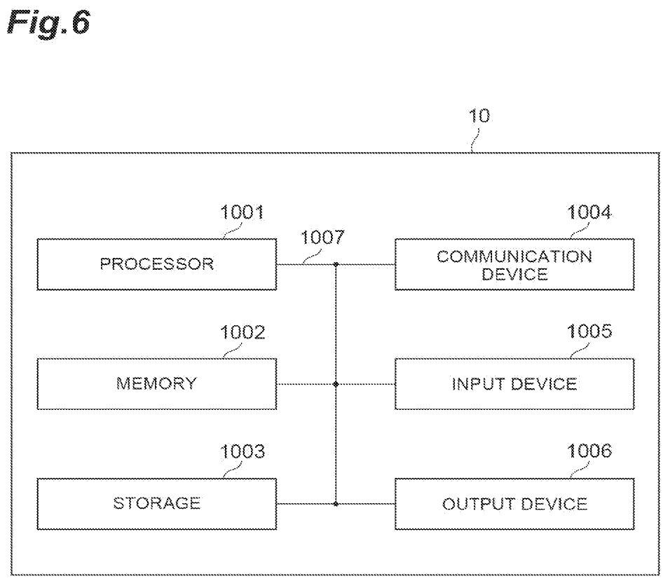

For example, the feature amount output model generation system 10 in an embodiment of the present disclosure may function as a computer that performs information processing of the present disclosure. FIG. 6 is a diagram illustrating an example of a hardware configuration of the feature amount output model generation system 10 according to an embodiment of the present disclosure. The above-described feature amount output model generation system 10 may be physically configured as a computer device including a processor 1001, a memory 1002, a storage 1003, a communication device 1004, an input device 1005, an output device 1006, a bus 1007, and the like.

Meanwhile, in the following description, the word “device” may be replaced with “circuit,” “unit,” or the like. The hardware configuration of the feature amount output model generation system 10 may be configured to include one or a plurality of devices shown in the drawings, or may be configured without including some of the devices.

The processor 1001 performs an arithmetic operation by reading predetermined software (a program) onto hardware such as the processor 1001 or the memory 1002, and thus each function of the feature amount output model generation system 10 is realized by controlling communication in the communication device 1004 or controlling at least one of reading-out and writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, each function in the feature amount output model generation system 10 may be realized by the processor 1001.

In addition, the processor 1001 reads out a program (a program code), a software module, data, or the like from at least one of the storage 1003 and the communication device 1004 into the memory 1002, and executes various types of processes in accordance therewith. An example of the program which is used includes a program causing a computer to execute at least some of the operations described in the foregoing embodiment. For example, each function in the feature amount output model generation system 10 may be realized by a control program which is stored in the memory 1002 and operates in the processor 1001. Although the execution of various types of processes by one processor 1001 has been described above, these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (a program code), a software module, or the like that can be executed in order to carry out information processing according to an embodiment of the present disclosure.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium included in the feature amount output model generation system 10 may be, for example, a database including at least one of the memory 1002 and the storage 1003, a server, or another suitable medium.

The communication device 1004 is hardware (a transmitting and receiving device) for performing communication between computers through at least one of a wired network and a wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be configured using a single bus, or may be configured using different buses between devices.

In addition, the feature amount output model generation system 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of the processing sequences, the sequences, the flowcharts, and the like of the aspects/embodiments described above in the present disclosure may be changed as long as they are compatible with each other. For example, in the methods described in the present disclosure, various steps as elements are presented using an exemplary order but the methods are not limited to the presented specific order.

The input or output information or the like may be stored in a specific place (for example, a memory) or may be managed using a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in the present disclosure may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Hereinbefore, the present disclosure has been described in detail, but it is apparent to those skilled in the art that the present disclosure should not be limited to the embodiments described in the present disclosure. The present disclosure can be implemented as modified and changed aspects without departing from the spirit and scope of the present disclosure, which are determined by the description of the scope of claims. Therefore, the description of the present disclosure is intended for illustrative explanation only, and does not impose any limited interpretation on the present disclosure.

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” which are used in the present disclosure are used interchangeably.

In addition, information, parameters, and the like described in the present disclosure may be expressed using absolute values, may be expressed using values relative to a predetermined value, or may be expressed using other corresponding information.

The term “determining” which is used in the present disclosure may include various types of operations. The term “determining” may include regarding operations such as, for example, judging, calculating, computing, processing, deriving, investigating, looking up/search/inquiry (for example, looking up in a table, a database or a separate data structure), or ascertaining as an operation such as “determining.” In addition, the term “determining” may include regarding operations such as receiving (for example, receiving information), transmitting (for example, transmitting information), input, output, or accessing (for example, accessing data in a memory) as an operation such as “determining.” In addition, the term “determining” may include regarding operations such as resolving, selecting, choosing, establishing, or comparing as an operation such as “determining.” That is, the term “determining” may include regarding some kind of operation as an operation such as “determining.” In addition, the term “determining” may be replaced with the term “assuming,” “expecting,” “considering,” or the like.

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. For example, “connection” may be read as “access.” In the case of use in the present disclosure, two elements can be considered to be “connected” or “coupled” to each other using at least one of one or more electrical wires, cables, and printed electric connections or using electromagnetic energy or the like having wavelengths in a radio frequency range, a microwave area, and a light (both visible light and invisible light) area as non-restrictive and non-comprehensive examples.

An expression “on the basis of” which is used in the present disclosure does not refer to only “on the basis of only,” unless otherwise described. In other words, the expression “on the basis of” refers to both “on the basis of only” and “on the basis of at least.”

Any reference to elements having names such as “first” and “second” which are used in the present disclosure does not generally limit amounts or an order of the elements. The terms can be conveniently used to distinguish two or more elements in the present disclosure. Accordingly, reference to first and second elements does not mean that only two elements are employed or that the first element has to precede the second element in any form.

In the present disclosure, when the terms “include,” “including,” and modifications thereof are used, these terms are intended to have a comprehensive meaning similarly to the term “comprising.” Further, the term “or” which is used in the present disclosure is intended not to mean an exclusive logical sum.

In the present disclosure, when articles are added by translation like, for example, “a,” “an” and “the” in English, the present disclosure may include that nouns that follow these articles are plural forms.

In the present disclosure, an expression “A and B are different” may mean that “A and B are different from each other.” Meanwhile, the expression may mean that “A and B are different from C.” The terms “separated,” “coupled,” and the like may also be construed similarly to “different.”

### REFERENCE SIGNS LIST

10 Feature amount output model generation system
11 Singing data acquisition unit
12 Division unit
13 Feature amount output model generation unit
1001 Processor
1002 Memory
1003 Storage
1004 Communication device
1005 Input device
1006 Output device
1007 Bus

1. A feature amount output model generation system configured to generate a feature amount output model for inputting information based on singing data which is time-series voice data relating to singing of a song and outputting a feature amount of the singing data, the system comprising circuitry configured to:
acquire singing data for each of a plurality of songs used to generate a feature amount output model;
divide each piece of the acquired singing data into a plurality of temporal sections; and
generate a feature amount output model for inputting information based on singing data of the divided section and outputting a feature amount of the singing data of the section from the divided singing data through machine learning,
wherein the circuitry performs machine learning according to criteria based on a distance between feature amounts of singing data relating to the same song and a distance between feature amounts of singing data relating to songs different from each other.

2. The feature amount output model generation system according to claim 1, wherein the circuitry performs machine learning so that the distance between feature amounts of singing data relating to the same song is shorter than the distance between feature amounts of singing data relating to songs different from each other.

3. The feature amount output model generation system according to claim 1, wherein the circuitry determines a section of singing data to be used for machine learning on the basis of a distance between feature amounts which are output by a feature amount output model in a process of generation.

4. The feature amount output model generation system according to claim 1, wherein the circuitry acquires singing data including data indicating a length of a time-series pitch.

5. The feature amount output model generation system according to claim 4, wherein the circuitry converts data indicating a length of a pitch included in the divided singing data into a word which is a character string corresponding to the length of a pitch for each consecutive identical pitch, and generates a feature amount output model for inputting information based on the converted word.

6. The feature amount output model generation system according to claim 2, wherein the circuitry determines a section of singing data to be used for machine learning on the basis of a distance between feature amounts which are output by a feature amount output model in a process of generation.
